(19) United States
(12) Patent Application Publication
(10) Pub. No.: US 2024/0224012 A1
(43) Pub. Date: Jul. 4, 2024

(54) ARRANGEMENT FACILITATING LOW-COST BLOCK CHAIN INFRASTRUCTURE FOR INCENTIVE-PROGRAM COMPENSATION MANAGEMENT

(71) Applicant: United States Cellular Corporation, Chicago, IL (US)

(72) Inventors: Douglas William VARNEY, Naperville, IL (US); Narothum Saxena, Hoffman Estates, IL (US); Michael S. Irizarry, Barrington Hills, IL (US)

(21) Appl. No.: 18/091,610

(22) Filed: Dec. 30, 2022

(51) Int. Cl. H04W 4/50; H04W 68/00

(52) U.S. Cl. CPC H04W 4/50; H04W 68/00

(57) ABSTRACT

A networked facilitator system is described that, in cooperation with a block chain on a network, carried out managing smart contracts associated with incentivized attention of a recipient sponsored by an application provider. The application provider submits a smart contract for incorporation into a block of the block chain, where the smart contract defines a compensated action performed by the recipient. The facilitator is configured to receive an incentivized attention definition corresponding to the smart contract and maps the received incentivized attention definition to an address of the recipient. Thereafter, the facilitator operates to interact with the recipient and the block chain smart contract to validate completion of required acts and invoke a consensus function to cause issuance of compensation to the recipient pursuant to the completed smart contract on the block chain.

### FIELD OF THE INVENTION

The present disclosure generally relates to block chain technologies. More particularly, the present disclosure is directed to a network-based arrangement supporting low network and computer resource consumption associated with compensation management associated with an incentive-program.

### BACKGROUND OF THE INVENTION

Mobile wireless technology has experienced vast improvements in both the ability to handle vast volumes of information at high speeds as well as handling high numbers of simultaneous users by radio access network (RAN) nodes. Additionally the cost of subscribing to mobile wireless network services has reduced relative to the amount of data and service levels (data rates) provided to subscribers. Additionally, the cost of incorporating mobile wireless communications capabilities into a variety of machines/devices has fallen substantially. The result is that mobile wireless services are now economically practical for a variety of activities that were previously considered cost-prohibitive.

Mobile service providers are now seeking to implement services with an aim to obtain and retain customer attention in the face of an increase in number and types of communication and requests from multiple parties. It is becoming necessary for mobile service providers to provide economic incentives that compensate users for providing the requested attention on an instance basis (e.g. watching a sponsor's marketing video), thereby providing quantifiable rewards for customers' attention.

It is also difficult for the mobile service provider to securely and cost effectively implement such incentive-based attention retention infrastructures. An example is with A2P (Application-to-Person) messaging volume increasing as a result of such programs. In such case, customers are subjected to an increase in clutter of messaging in a mobile user's messaging interface making it difficult for a message from an application to be read by a recipient (let alone be acted upon).

Another challenge for a mobile service provider seeking to implement such a program is a need to cost effectively offer to monetarily compensate a customer for reading/interacting and taking action on any request in a manner that is trusted by the application and the person. In many cases, compensation for individual instances of various rewarded activities is very small (even a few cents). A challenge, when implementing such programs, is to carry out operations on a networked framework providing low-resource consumption of network and computing resources. A low transaction/management cost arrangement supporting an incentive-based transaction avoids an economically unjustifiable imbalance between costs of network and computing resources and value of the incentive-based transactions supported by the network and computing resources. As such, high per-transaction costs associated with operating and maintaining secure network and computing resources is a significant hurdle to wide-spread acceptance of incentivizing customer attention.

### SUMMARY OF THE INVENTION

To address technical challenges faced with providing secure and low cost computing and network resource attention incentivized arrangements, a system and method are disclosed for a networked facilitator system to carry out, in cooperation with a block chain on a network, a method for managing smart contracts associated with incentivized attention of a recipient sponsored by an application provider, and wherein the application provider submits a smart contract for incorporation into a block of the block chain, where the smart contract defines a compensated action performed by the recipient. The facilitator includes a processor and a non-transitory computer-readable medium including computer-executable instructions that, when executed by the processor, cause the facilitator to carrying out the method for managing smart contracts.

The method includes receiving, from the application provider, an incentivized attention definition corresponding to the smart contract, wherein the incentivized attention definition includes an address of the smart contract on the block chain, and mapping the received incentivized attention definition to an address of the recipient. Additionally, the method includes issuing, to the recipient, a request for incentivized attention that includes the address of the smart contact on the block chain, and receiving, from the recipient, a notification indicating the recipient has completed an activity required under the smart contract corresponding to the address of the smart contract. Moreover, the method includes issuing, to the block chain, a call to a function on the smart contract to validate activity completion by the recipient device, wherein the call initiates operation of a consensus mechanism on the block chain to further perform a compensation distribution operation on the smart contract.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic diagram of an exemplary networked arrangement for carrying out a block chain-based incentivized attention arrangement in accordance with the present disclosure;

FIG. 2 is a schematic diagram of another exemplary networked arrangement for carrying out a block chain-based incentivized attention arrangement in accordance with the present disclosure;

FIG. 3 is a schematic diagram depicting a block chain structure for use in accordance with the present disclosure;

FIG. 4 is a sequence diagram summarizing an exemplary set of operations carried out by interacting networked entities in accordance with the present disclosure; and

FIG. 5 is a sequence diagram summarizing an alternative exemplary set of operations carried out by interacting networked entities in accordance with the present disclosure.

### DETAILED DESCRIPTION OF THE DRAWINGS

A system, in accordance with the present disclosure, includes a set of networked components that carry out inter-related transactions associated with an incentivized attention arrangement. The system, implements a messaging protocol that enables cost effectively orchestrating compensating users, in small increments (even a few cents), on an interaction instance basis (e.g. read/interact and take action on a received message) on a mobile wireless device.

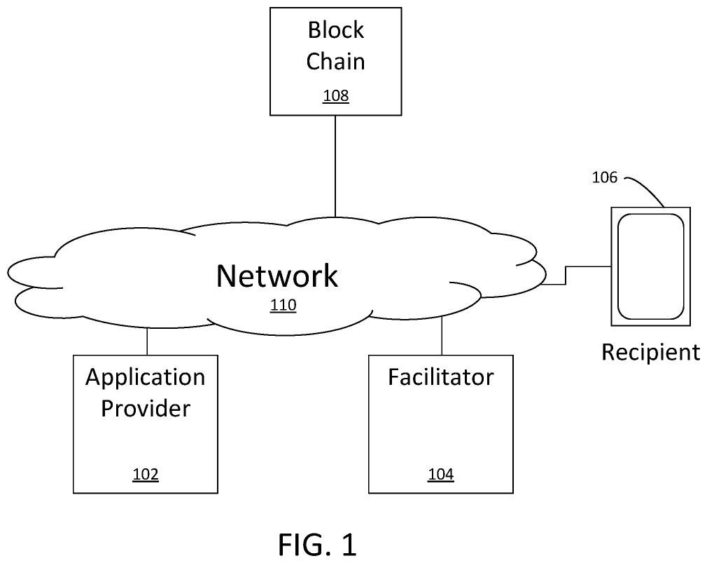

Turning briefly to FIG. 1, an exemplary networked communications and computing environment is generally depicted for carrying out incentivized attention transactions on an attention activity instance basis. An application provider 102 is a source of requests (i.e. a sponsor of an incentivized attention campaign) for incentivized attention. A facilitator 104 operates the networked servers (e.g., cloud servers) providing streaming content (e.g. advertisements) to users represented by a recipient mobile wireless device 106. The exemplary network environment also includes a block chain server 108. Communications between the identified components are supported by a network 110, corresponding to the Internet and various edge networks connecting the illustrated components thereto.

By way of introduction, the networked components facilitate the generalized incentivized attention program-related operations of: (a) delivering an incentivized attention request to the user of the device 106, (b) indicating to the user of the device 106 that they will be compensated for interacting/responding to the delivered request (with the compensation being guaranteed by a trusted party), (c) verifying an activity associated with the incentivized attention request is completed by the user of the device 106, (d) transferring compensation in an agreed upon amount to the user, and (e) providing an accounting of actions to all involved entities.

An example of an implementation of the above-summarized operations is an A2P message arrangement. In such arrangement, the application provider 102 submits a smart contract to the block chain 108, and the smart contract executes to record that a user of the recipient device 106 has met incentivized attention requirements under the smart contract (e.g., the user of the device 106 has read and provided an indication of completing any required actions associated with the incentivized attention transaction defined by the smart contract) by taking an action on incentivized attention request that is confirmed by the facilitator 104. Successful completion of actions/communications defined under the smart contract results in a transfer of compensation (e.g., digital currency) to the user of the recipient device 106. Importantly, because execution of a contract on the block chain 108 is a relatively costly transaction. The incentivized attention implementation scheme described herein minimizes such transactions by having the facilitator 104 perform actions on the block chain 108 in an aggregated manner, and requiring the recipient device 106 to merely ready contents therefrom.

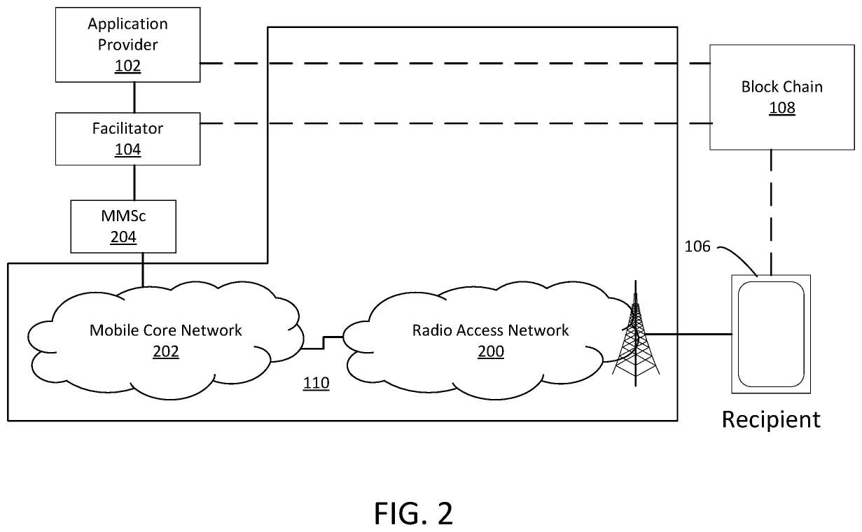

Turning to FIG. 2, a more particular implementation of the generalized network environment of FIG. 1, is provided where the network 110 comprises a mobile network including a radio access network (RAN) 200, a mobile core network 202, and a multimedia messaging center (MMSC) 204. The application provider 102 interfaces to the facilitator 104 via representational state transfer (REST) with a JavaScript Object Notation (JSON) payload. The facilitator 104 communicates with the multimedia messaging center (MMSC) 204 via 3GPP defined MM7 interface. The MMSC 204 communicates with the recipient device 106 via the mobile core network 202 and the radio access network 200 to deliver from the facilitator 104, on behalf of the application provider 102, incentivized attention requests to the recipient device 106.

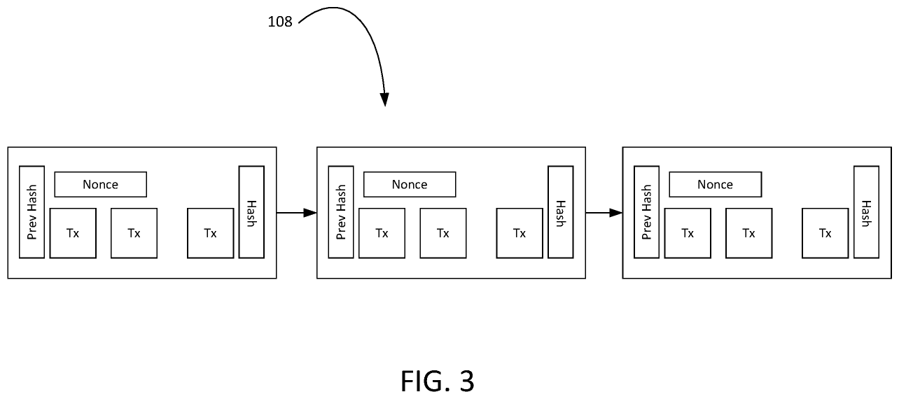

Turning to FIG. 3, the block chain 108 is a distributed ledger technology. The block chain 108 may be implemented as available to all (permissionless) or as restricted to an allowed set of entities (permissioned). The block chain 108 comprises a set of blocks. Each block includes a pointer to a next block in the block chain 108. Each block contains a set of discrete transactions (Tx). Each block also includes integrity verification data (e.g. a hash). The type of integrity verification data used varies in accordance with various block chain technology implementations of the present disclosure.

Blocks of the block chain 108 incorporate information and operations constituting a mechanism for facilitating establishing “consensus” between parties to a contract between the application provider 102 and the recipient device 106 regarding completion of actions required to meet requested incentivized attention activities by the recipient device 106. Requirements for establishing consensus can be extremely computational-resource intensive. An example of a computational resource intense consensus mechanism is the one used for establishing “proof-of-work” for issuance of a BitCoin. A consensus mechanism of the present disclosure (e.g., proof-of-stake or Byzantine General), in contrast, requires minimal computational resources and facilitates high consensus reaching rates.

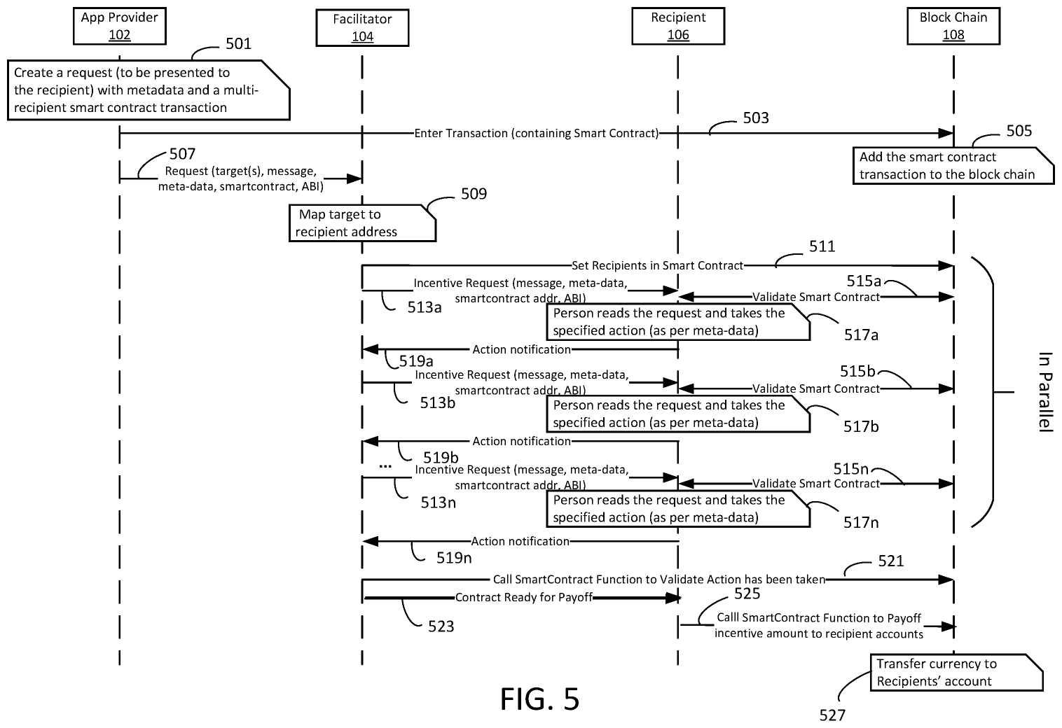

Efficiency of the block chain 108, in accordance with an implementation (see FIG. 5 described herein below), is significantly increased by aggregating, by the facilitator 104, contract execution for multiple recipients in “off-chain” transactions. Such bundling of smart contract execution, to reach consensus with respect to incentivized attention requests completed by recipient devices, such as the recipient device 106, does not reduce the transparency of the smart contract execution. However, the bundling introduces a delay in registering completion of a requested action and reaching a consensus state on a block of the block chain. In a case where bundling is performed on a set number of smart contract completed acts, delays can be maintained at an acceptable threshold value by incorporating a watchdog timer. Upon completion of a time period of the watchdog timer, the currently accumulated contract completions are reported by the facilitator 104 on the block chain 108 regardless of the current number of accumulated contract completions by recipient devices received by the facilitator 104. As such, configuration of the facilitator 104 to accumulate/bundle completions and then report the completions as a single transaction on the block chain 108 greatly improves the cost-effectiveness of implementing an incentivized attention service platform.

While the logic incorporated into the consensus mechanism will vary in accordance with various implementations, in all instances the consensus mechanism incorporates logic for ensuring compliance/completion of all requirements set forth in a “smart contract” defining the requirements and reward for a completing an instance of a defined requested incentivized attention. Thus, the block chain 108 supports “smart contracts” such that after an instance of a smart contract is established on a block of the block chain 108, an “executed” function is exposed such that state changes are recorded as transactions (Tx) on the appropriate indicated block of the block chain 108.

Having described a general architecture supporting secure verified completion of requested incentivized attention instances, attention is directed to sequence diagrams summarizing operation of the system to carry out a block chain-facilitated requested incentivized attention instance.

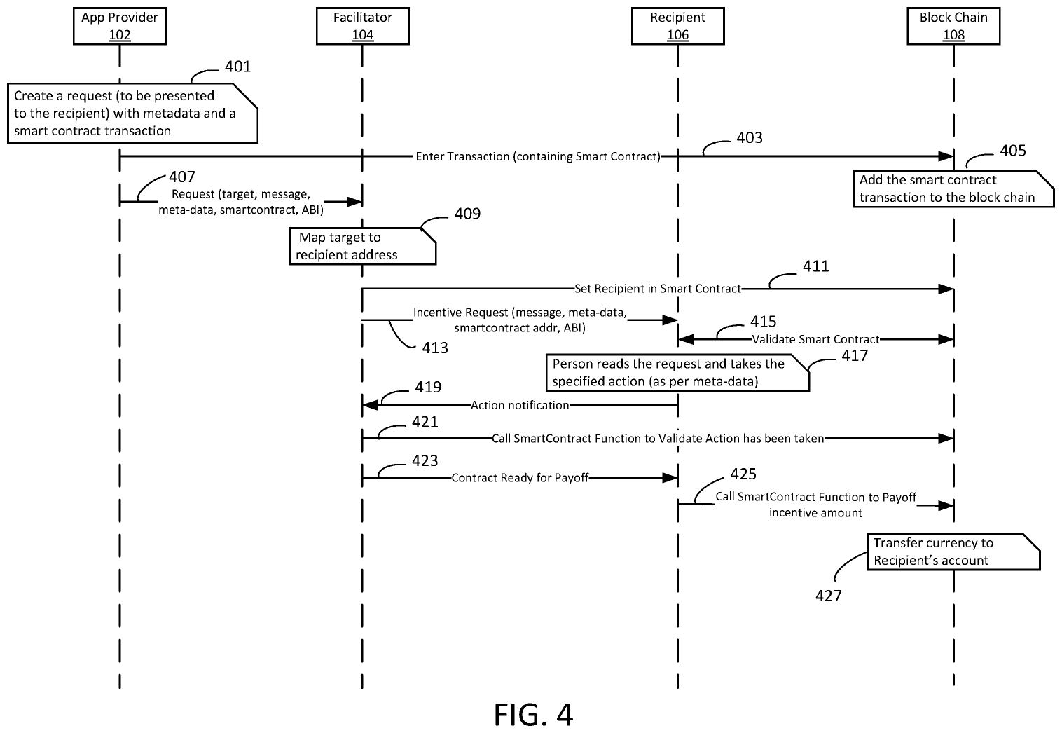

Turning to FIG. 4 a sequence diagram provides a series of operations and communication transactions between the components of FIG. 1 to carry out an incentivized attention smart contract between an application provider 102 and a recipient 106, with consensus on the smart contract being established by operation of transactions recorded on the block chain 108 in accordance with messaging between the application provider 102, facilitator 104 and recipient device 106 and the block chain 108 that incorporate a consensus mechanism.

Initially, during 401, the application provider 102 creates both: (1) a definition of an incentivized attention request to be presented to a recipient, and (2) a smart contract transaction. During 403, the application provider 102 submits the smart contract transaction to the block chain 108.

During 405, the smart contract transaction is incorporated into the consensus mechanism of blocks within the block chain 108 in accordance with known use/implementation of block chain technology.

Thereafter, during 407, the application provider 102 transmits to the facilitator 104 the incentivized attention request definition (created during 401). The definition includes: request target identification, message, meta-data that enables the facilitator 104 to determine that the action has been taken, the smart contract address, and the smart contract function signature (e.g., application binary interface—ABI)).

The facilitator 104, during 409, processes the target identification to determine a recipient (a group of recipient types meeting a specified filter of recipients provided by the target identification) and an address (for each determined recipient) using local database(s) and/or any other recipient pool enumeration/lists such as knowledge of high-level geolocation information as is available from cellular network cell site data.

In accordance with the present illustrative example, where a smart contract is established and completed for the recipient device 106, during 411 the facilitator 104 provides an address assigned to the recipient 106 in a block of the block chain 108 corresponding to a smart contract instance for the recipient 106 (established in accordance with the request created during 401).

During 413, the facilitator 104 issues a request message to the recipient device 106 corresponding to the incentivized attention request created during 401. The request message includes the message, meta-data, and an address of the smart contract and the ABI (per information received during 407 described above). An example delivery mechanism is through a multimedia messaging service (MMS) or a rich communication service (RCS).

During 415, the recipient 106 validates the smart contract by reference to a particular block of the block chain 108 corresponding to the provided address of the smart contract received from the facilitator 104 during 413.

Thereafter, during 417 the recipient device 106 is operated (by a user) to perform activity in accordance with the incentivized attention request, and thereafter during 419 the recipient messages the facilitator 104 with an indicator that the requested activity was carried out. Such indication may be a confirmation code or other proof of completing the requested/required action for compensation in accordance with the smart contract terms.

During 421, the facilitator 104 issues a message to the block chain 108 invoking a call to a function on the smart contract to validate the completed actions by the recipient device 106, and initiating operations of the consensus mechanism to complete the smart contract. In accordance with an enhanced embodiment described herein below with reference to FIG. 5, this operation may be delayed such that the facilitator 104 is able to report completion of actions by multiple devices to the block chain 108, thereby reducing transaction costs associated with messaging associated with this reporting operation.

During 423, the facilitator 104 notifies the recipient device 106 that the smart contract has achieved a state of completion wherein issuance of compensation to (the user of) the recipient device 106 is now authorized.

During 425, the recipient device 106 issues a message to the smart contract function of the block chain 108 requesting payment of compensation in an amount indicated in the terms of the smart contract.

During 427, the block chain 108 executes a compensation allocation function of the smart contract to issue value to an identified account in accordance with a payout arrangement and pursuant to terms of the smart contract.

Turning to FIG. 5 a sequence diagram provides a series of operations and communication transactions between the components of FIG. 1 to carry out an incentivized attention smart contract between an application provider 102 and multiple actions performed by a single recipient (e.g. a recipient 106) or multiple distinct recipients, with consensus on the smart contract being established by operation of transactions recorded on the block chain 108 in accordance with messaging between the application provider 102, facilitator 104 and recipient device 106 and the block chain 108 that incorporate a consensus mechanism.

The flow described above with reference to FIG. 4 is enhanced to have multiple recipients or multiple actions by a single recipient be covered by a single contract. The facilitator 104 maintains the state for recipients that have completed the specified action and when a sufficient number of recipients have taken the specified action or a timer expires, the facilitator 104 issues a single consolidated notification message to the block chain 108 invoking a call to validate the completed actions on each contract corresponding to each of the consolidated completed actions of the recipients, and initiating operations of the consensus mechanism to complete the smart contract as shown in the sequence diagram of FIG. 5. This aggregation enables more efficient interaction with the block chain 108 at the trade-off of a delay in obtaining consensus on contracts and transferring currency to recipients.

Initially, during 501, the application provider 102 creates both: (1) a definition of an incentivized attention request to be presented to a group of recipients, and (2) a smart contract transaction. During 503, the application provider 102 submits the multi-recipient smart contract transaction to an organization entity managing the block chain 108.

During 505, the organization entity incorporates the smart contract transaction into the consensus mechanism of blocks within the block chain 108 in accordance with known use/implementation of block chain technology.

Thereafter, during 507, the application provider 102 transmits to the facilitator 104 the incentivized attention request definition (created during 401). The definition includes: request target identification, message, meta-data that enables the facilitator 104 to determine that the action has been taken, the smart contract address, and the smart contract function signature (e.g., ABI)). In this case the target identification may identify multiple distinct recipient devices.

The facilitator 104, during 509, processes the target identification to determine a recipient (a group of recipient types meeting a specified filter of recipients provided by the target identification) and an address (for each determined recipient) using local database(s) and/or any other recipient pool enumeration/lists such as knowledge of high-level geolocation information as is available from cellular network cell site data.

The next stages (indicated by sub-identifiers a, b and n) are carried out in parallel by distinct recipient devices.

In accordance with the present illustrative example, during 511 the facilitator 104 provides a set of addresses assigned to the plurality of recipients (e.g. the recipient 106) in a block of the block chain 108 corresponding to a smart contract instance for the recipient 106 (established in accordance with the request created during 401).

During 513a, 513b, . . . 513n, the facilitator 104 issues a request message to the appropriate recipient device (of multiple identified target recipient devices during 507) corresponding to the incentivized attention request created during 401. The request message includes the message, meta-data, and an address of the smart contract and the ABI (per information received during 407 described above). An example delivery mechanism is through MMS or RCS.

During 515a, 515b, . . . 515n, the target recipient device validates the smart contract by reference to a particular block of the block chain 108 corresponding to the provided address of the smart contract received from the facilitator 104 during 413.

Thereafter, during 517a, 517b, . . . 517n each of the target recipient device is operated (by a user) to perform activity in accordance with the incentivized attention request, and thereafter during 519a, 519b, . . . 519n the recipient devices messages the facilitator 104 with an indicator that the requested activity was carried out. Such indication may be a confirmation code or other proof of completing the requested/required action for compensation in accordance with the smart contract terms.

In accordance with an efficiency aiding aspect of the present example, the facilitator accumulates (without performing the operation that follows) messages received from the recipient devices until a threshold quantity of responses (or a watchdog timer period expires) before performing operation 521 described below.

During 521, the facilitator 104 issues a multi-acknowledgement message to the block chain 108 invoking a call to a function on the smart contract to validate the completed actions by the multiple distinct recipient devices for which a response was successfully received (operation 519a, 519b, . . . 519n), and initiating operations of the consensus mechanism to complete the smart contract on behalf of each indicated recipient device in the multi-acknowledgement message.

During 523, the facilitator 104 notifies each of the recipient devices that the smart contract has achieved a state of completion wherein issuance of compensation to (the user of) the recipient device 106 is now authorized.

During 525, the recipient devices each issue a message to the smart contract function of the block chain 108 requesting payment of compensation in an amount indicated in the terms of the smart contract.

During 527, the block chain 108 executes a compensation allocation function of the smart contract to issue value to an identified account in accordance with a payout arrangement and pursuant to terms of the smart contract for each recipient device.

Several further enhancements are contemplated in accordance with various alternative/enhanced implementations of the above-described systems and operation thereof. For example, during an initial configuration stage, a user of the recipient device 106 may be presented with options relating to how a particular incentivized attention request will be carried out, such as whether a poll will be via video or simple text/graphics presented on a user interface. On the Application provider 102/Facilitator 104 side, optionally a configurable parameter may be set to present a request for incentivized attention in a particular mode based upon a network state (e.g. available network bandwidth).

In yet another implementation, all messaging between the recipient devices and the block chain 108 entity are passed through the facilitator 104, thereby avoiding potential difficulties with supporting interfaces to a variety of potential user/recipient devices by the block chain 108 entity. Such consolidation may also facilitate reducing the number of messaging transactions handled by the block chain 108 entity.

All references, including publications, patent applications, and patents, cited herein are hereby incorporated by reference to the same extent as if each reference was individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising.” “having.” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method, carried out by a networked facilitator node and a block chain on a network, for managing smart contracts associated with incentivized attention of a recipient sponsored by an application provider, wherein the application provider submits a smart contract for incorporation into a block of the block chain, where the smart contract defines a compensated action performed by the recipient, wherein the method carried out by the facilitator node comprises:
receiving, from the application provider, an incentivized attention definition corresponding to the smart contract, wherein the incentivized attention definition includes an address of the smart contract on the block chain;
mapping the received incentivized attention definition to an address of the recipient;
issuing, to the recipient, a request for incentivized attention that includes the address of the smart contact on the block chain;
receiving, from the recipient, a notification indicating the recipient has completed an activity required under the smart contract corresponding to the address of the smart contract; and
issuing, to the block chain, a call to a function on the smart contract to validate activity completion by the recipient device, wherein the call initiates operation of a consensus mechanism on the block chain to further perform a compensation distribution operation on the smart contract.

2. The method of claim 1 further comprising:
issuing, to the recipient after issuing the call to cause the compensation distribution operation, a notification that the smart contract is in a state where the compensation is ready for payout to the recipient.

3. The method of claim 1, wherein the smart contract supports completion of a defined incentivized attention action by multiple recipients, and
wherein after performing the issuing a request for incentivized attention to multiple recipients, the facilitator aggregates multiple received notifications indicating completion of a defined activity pursuant to the smart contract, and the facilitator issues a single call to the function on the smart contract corresponding to each one of the aggregated received notifications indicating completion of the defined activity.

4. The method of claim 1, wherein the incentivized attention definition specifies a filter for selecting, from a pool of candidate recipients, a set of qualified recipients to receive the request for incentivized attention corresponding to the smart contract.

5. The method of claim 1, wherein the facilitator issues the request for incentivized attention via a multimedia messaging service.

6. The method of claim 1, wherein the facilitator issues the request for incentivized attention via a rich communication service.

7. A networked facilitator system configured to carry out, in cooperation with a block chain on a network, a method for managing smart contracts associated with incentivized attention of a recipient sponsored by an application provider, wherein the application provider submits a smart contract for incorporation into a block of the block chain, where the smart contract defines a compensated action performed by the recipient, wherein the facilitator comprises:
a processor; and
a non-transitory computer-readable medium including computer-executable instructions that, when executed by the processor, cause the facilitator to carrying out the method for managing smart contracts comprising:
receiving, from the application provider, an incentivized attention definition corresponding to the smart contract, wherein the incentivized attention definition includes an address of the smart contract on the block chain;
mapping the received incentivized attention definition to an address of the recipient;
issuing, to the recipient, a request for incentivized attention that includes the address of the smart contact on the block chain;
receiving, from the recipient, a notification indicating the recipient has completed an activity required under the smart contract corresponding to the address of the smart contract; and
issuing, to the block chain, a call to a function on the smart contract to validate activity completion by the recipient device, wherein the call initiates operation of a consensus mechanism on the block chain to further perform a compensation distribution operation on the smart contract.

8. The system of claim 7, wherein the method further comprises:
issuing, to the recipient after issuing the call to cause the compensation distribution operation, a notification that the smart contract is in a state where the compensation is ready for payout to the recipient.

9. The system of claim 7, wherein the smart contract supports completion of a defined incentivized attention action by multiple recipients, and
wherein after performing the issuing a request for incentivized attention to multiple recipients, the facilitator aggregates multiple received notifications indicating completion of a defined activity pursuant to the smart contract, and the facilitator issues a single call to the function on the smart contract corresponding to each one of the aggregated received notifications indicating completion of the defined activity.

10. The system of claim 7, wherein the incentivized attention definition specifies a filter for selecting, from a pool of candidate recipients, a set of qualified recipients to receive the request for incentivized attention corresponding to the smart contract.

11. The system of claim 7, wherein the facilitator is configured to issue the request for incentivized attention via a multimedia messaging service.

12. The system of claim 7, wherein the facilitator is configured to issue the request for incentivized attention via a rich communication service.
